(19) United States
(12) Patent Application Publication
(10) Pub. No.: US 2005/0019687 A1
(43) Pub. Date: Jan. 27, 2005

(54) Non-magnetic one-component toner

(76) Inventor: Hyun-wook Bae, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/896,058

(22) Filed: Jul. 22, 2004

(30) Foreign Application Priority Data
Jul. 23, 2003 (KR) 2003-50489
Jan. 7, 2004 (KR) 2004-881

(51) Int. Cl. G03G 9/08

(52) U.S. Cl. 430/108.6; 430/108.7

(57) ABSTRACT

A non-magnetic one-component toner is produced to provide a uniform image density. The non-magnetic one-component toner includes coloration particles that include a binder resin, a pigment, and a charge control agent; and a surface additive including 0.1-4 wt % of one or more selected from the group consisting of silica, titanium oxide, silicon carbide, and alumina, and a resin bead where the surface additive has an average volumetric particle size of 0.01-15 μm where the percentages are based on the total weight of the toner. The non-magnetic one-component toner provides a uniform image density for a long duration and prevents the formation of poor images such as fogging, without performing a separate process such as increasing of the pressure of a cleaning blade or improving the surface smoothness of a latent image drum.

### BACKGROUND OF THE INVENTION

This application claims priority from Korean Patent Application No. 2003-50489 filed on Jul. 23, 2003 and No. 2004-881 filed on Jan. 7, 2004, in the Korean Intellectual Property Office, the disclosures of which are incorporated by reference in their entirety.

1. Field of the Invention

The present invention relates to a toner for a non-contact developing apparatus. More particularly, the invention is directed to a non-magnetic one-component toner for a non-contact developing apparatus that can prevent image contamination such as fogging in a non-image area.

2. Description of the Related Art

An inkjet printer and a laser printer are currently widely used. The ink-jet printer is used as a personal printer due to the slow print speed. On the other hand, the laser printer is suitable in an office environment in which it is linked to several network computers to print large volumes. In laser printers, a latent image is created on an optical photoconductor (OPC) using a laser. Thereafter, a toner is attracted to the latent image of the OPC by an electric potential difference and then the latent image is transferred onto paper or other substrate, resulting in a visible image.

The current laser printers that are commercially available were primarily developed as black and white dry printers. In the black and white dry printer, a toner is charged by friction and then transferred to a latent image of an OPC by an electrical potential difference. Even though the black and white dry printer causes environmental problems such as dust generation due to toner particles, there is an advantage in that it can be easily manufactured at low costs in small particle sizes.

Generally, a developer is a mixture of a toner and a carrier. In the absence of a carrier, a toner is used as a developer.

Dry developers are referred to as a one-component developer or a two-component developer according to a charge method of toner particles. Dry developers are also referred to as a magnetic toner or a non-magnetic toner according to the transfer mechanism of charged toner particles to a latent image. The one-component developer is a developer in which a toner is charged by friction between toner particles or between toner particles and a sleeve. The two-component developer is a developer in which a toner is charged by friction between non-magnetic toner particles and magnetic carrier particles. The two-component developer ensures a relatively stable and good recording image and a high-speed development, but has several disadvantages such as degradation of the carrier, variations of the mixture ratio between a toner and the carrier, and the increase in the size of the developing apparatus. Therefore, the one-component developer has been widely used because it provides miniaturization of a developing apparatus, low costs, and high reliability. In the non-magnetic toner, toner particles are transferred to a latent image by the flowability of the toner particles instead of a magnetic force. On the other hand, in the magnetic toner, toner particles exhibit magnetic property by addition of ferrite or the like, and thus, are transferred to a latent image by a magnetic force. The non-magnetic toner, which does not contain a magnetic material, is advantageous in that toner costs are low and color printing is possible.

Generally, a dry toner includes a pigment, a charge control agent (CCA) that adjusts the charge amount of the toner, a binder resin that binds the pigment and the charge control agent, and a releasing agent that facilitates the separation of a transfer medium after the transfer. A surface additive is added to the surfaces of toner particles to impart functionality to the toner particles or to enhance the physical properties of the toner particles.

An image forming method includes a charging process in which an OPC made of a photoconductive material is electrostatically charged; a light-exposing process in which a latent image is created on the surface of the OPC by a laser; a developing process in which the latent image is developed with a developer to form a toner image; a transferring process in which the toner image is transferred to a transfer medium such as a paper; a fixing process in which the toner is fixed on the transfer medium by heating or pressing; and a cleaning process in which residues including toner particles that remain on a latent image drum after the transfer are cleaned. The desired copies or prints are obtained by repeating these processes. Among these processes, the developing process is divided into a contact-type and a non-contact type developing process. The contact-type developing process is a process in which a latent image is developed with a developer by a developing roller contacting with the surface of an OPC. The non-contact-type developing process is a process in which a developer is transported across a predetermined gap between a developing roller and an OPC by an electric force generated by an electric potential difference between a voltage applied to the developing roller and the electric potential of a latent image on the OPC, and the latent image is developed with the transported developer. The contact-type developing process may cause abrasion between the OPC and the developing roller. On the other hand, the non-contact-type developing process has advantages in that it provides excellent durability and high-resolution print quality due to development of the latent image by an electric force.

With respect to a dry developer used in a non-contact developing apparatus, flowability and electrical properties must not change with time and environmental conditions (for example, temperature, humidity). In particular, a developer used in a conventional non-contact-type, non-magnetic, one-component developing apparatus is charged by friction between the developer and a developer drum, a development control blade, and a developer feeding member. However, during repeated printing, a surface additive of a developer may be buried in a binder resin of the developer or detached from the developer due to stress. As a result, the flowability of the developer may decrease and physical adsorption of the developer can increase on the surfaces of the developer drum, the development control blade, and the developer feeding member. Consequently, frictional chargeability of the developer may be lowered and an uncharged or oppositely charged developer may be generated. Such an uncharged or oppositely charged developer tends to develop in a non-image area, thereby causing an image contamination such as a fog. To solve this problem, when a large amount of a surface additive is used, the charge amount of the developer and an image force between the developer and the developer drum increase, thereby decreasing the transfer amount of a toner to an OPC. Therefore, a development efficiency and an image density may be lowered. Furthermore, the use of a large amount of the surface additive may reduce the cleaning ability of a cleaning blade that removes the residual developer. Therefore, a charge roller is contaminated and a developer or a foreign substance remains on a latent image drum, thereby leading to a poor image quality such as image stains and vertical white/black stripes.

### SUMMARY OF THE INVENTION

The present invention is directed to a non-magnetic one-component toner for a non-contact developing apparatus that can provide a uniform image density for a longer duration and prevent poor imaging such as a fogging.

According to an aspect of the present invention, a non-magnetic one-component toner for a non-contact developing apparatusincludes: coloration particles including a binder resin, a pigment, and a charge control agent; and a surface additive including 0.1-4 wt % of one or more components selected from the group consisting of silica, titanium oxide, silicon carbide, and alumina, and a resin bead having an average volumetric particle size of 0.01-15 μm and where the wt % is based on the total weight of the toner.

These and other aspects of the invention will become apparent from the following detailed description of the invention which discloses various embodiments of the invention.

### DETAILED DESCRIPTION OF THE INVENTION

Hereinafter, the present invention will be described in more detail.

The toner particles according to the present invention include coloration particles and a surface additive. The coloration particles include a binder resin, a pigment, and a charge control agent. The surface additive includes 0.1-4 wt % of one or more components selected from silica, titanium oxide, silicon carbide, and alumina, and a resin bead with an average volumetric particle size of 0.01-15 μm where the weight percentages are based on the total weight of the toner. The polarity of the coloration particles and the polarity of the surface additive are appropriately adjusted according to the present invention to prevent the formation of poor images such as fogging.

The binder resin of the coloration particles may be selected from various known resins. For example, the binder resin may be one or more selected from styrene-based copolymers such as polystyrene, poly-P-chlorosytrene, poly-α-methylstyrene, styrene-chlorostyrene copolymer, styrene-propylene copolymer, styrene-vinyltoluene copolymer, styrene-vinylnaphthalene copolymer, styrene-methylacrylate copolymer, styrene-ethylacrylate copolymer, styrene-propylacrylate copolymer, styrene-butylacrylate copolymer, styrene-octylacrylate copolymer, styrene-methylmethacrylate copolymer, styrene-ethylmethacrylate copolymer, styrene-propylmethacrylate copolymer, styrene-butylmethacrylate copolymer, styrene-α-chloromethylmethacrylate copolymer, styrene-acrylonitrile copolymer, styrene-vinylmethylether copolymer, styrene-vinylethylether copolymer, styrene-vinylethylketone copolymer, styrene-butadiene copolymer, styrene-acrylonitrile-indene copolymer, styrene-maleic acid copolymer, and styrene-maleic ester copolymer; polymethylmethacrylate, polyethylmethacrylate, polybutylmethacrylate, and a mixture thereof; polyvinylchloride; polyvinylacetate; polyethylene; polypropylene; polyester; polyurethane; polyamide; epoxy resin; polyvinylbutyral resin; rosin; modified rosin; terpene resin; phenol resin; aliphatic or cycloaliphatic hydrocarbon resin; aromatic petroleum resin; chlorinated paraffin; and paraffin wax.

A black and white toner can use carbon black or an aniline black as the pigment. A non-magnetic toner according to the present invention is suitable for a color toner. The carbon black is used as a black pigment. Yellow pigments, magenta pigments, and cyan pigments can also be included to make different colored toners.

The yellow pigment may be condensed nitrogen compounds, isoindolinone compounds, anthraquinone compounds, azo metal complexes, or aryl imide compounds. For example, the pigment can be C.I. pigment yellow 12, 13, 14, 17, 62, 74, 83, 93, 94, 95, 109, 110, 111, 128, 129, 147, or 168.

The magenta pigment may be condensed nitrogen compounds, anthraquinones, quinacridone compounds, lake compounds of basic dyestuffs, naphthol compounds, benzoimidazole compounds, thioindigo compounds, or perylene compounds. For example, the magenta pigment can be C.I. pigment red 2, 3, 5, 6, 7, 23, 48:2, 48:3, 48:4, 57:1, 81:1, 144, 146, 166, 169, 177, 184, 185, 202, 206, 220, 221, or 254 may be used.

The cyan pigment may be copper phthalocyanine compounds and derivatives thereof, anthraquinone compounds, or lake compounds of basic dyestuffs. For example, cyan pigments can be C.I. pigment blue 1, 7, 15, 15:1, 15:2, 15:3, 15:4, 60, 62, or 66.

These pigments may be used alone or in combination of two or more types of pigments. A desired pigment is selected based on the color, saturation, brightness, weatherability, and dispersability in the toner.

The pigment may be used in an amount sufficient to color the toner so that a visible image is formed when the toner is developed. Preferably, the pigment is used in an amount of 2-20 parts by weight, based on 100 parts by weight of the binder resin in the coloration particles. If the content of the pigment is less than 2 parts by weight, a coloration effect may be insufficient. On the other hand, if it exceeds 20 parts by weight, the electric resistance of a toner may be lowered, which makes it difficult to obtain a sufficient frictional charge amount, thereby causing contamination.

The charge control agent that can be used herein is not particularly limited. A negative charge control agent may be selected from organic metal complexes or chelate compounds such as chrominum-containing azo dyes or monoazo metal complexes; salicylic compounds containing a metal such as chromium, iron, aluminum, and zinc; and organic metal complexes of aromatic hydroxycarboxylic acids or aromatic dicarboxylic acids. A positive charge control agent may be one or more selected from the group consisting of products modified with metal salts of nigrosine and its fatty acids; triphenylmethane derivatives; and quaternary ammonium salts such as tributylbenzylammonium 1-hydroxy-4-naphtosulfonate, tetrabutylammonium tetrafluoroborate, stearyidimethylbenzylammonium paratoluenesulfonate, stearyldimethylbenzylammonium methylsulfate, stearyldimethylphenethylammonium methylsulfate, distearyldimethylammonium chloride, and decyltrimethylammonium hydroxide.

Meanwhile, the toner particles of the present invention may further include a releasing agent and a high fatty acid or its metal salt. The releasing agent may be a polyalkylene wax such as low molecular weight polypropylene and low molecular weight polyethylene, paraffin wax, high fatty acid, or fatty acid amide. The high fatty acid or its metal salt serves to protect a photoconductor and prevent deterioration of development characteristics, leading to a high quality image.

The silica, titanium oxide, silicon carbide, or alumina, which is used as the surface additive in the present invention, serves to enhance the flowability of a toner. Preferably, the silica, titanium oxide, silicon carbide, or alumina has a particle size of 10-100 nm and is used in an amount of 0.1-4 wt % based on the total weight of the toner. If the content of the silica, titanium oxide, silicon carbide, or alumina is less than 0.1 wt %, an enhancement effect of flowability may be insufficient. On the other hand, if it exceeds 4 wt %, the physical properties of a toner such as the fixing property may be lowered.

Preferably, the resin bead as used herein has an average volumetric particle size of 0.01-15 μm, and more preferably 5-15 μm. The resin bead may be selected from polystyrene polymers, fluorine polymers, and acrylic polymers. If the particle size of the resin bead is less than 0.01 μm, the cleaning property may be reduced thereby reducing the ability of the developing apparatus to clean the residual toner particles from the drum. On the other hand, if the particle size exceeds 15 μm, frictional chargeability may be lowered, which lowers the feeding property of a developer and increases the fog density in the printed image.

Examples of the resin bead include, but are not limited to, styrene polymers such as polystyrene, poly-P-chlorostyrene, and poly-α-methylstyrene; fluorine polymers such as polytetrafluoroethylene, polytrifluorochloroethylene, and polyvinylidenefluoride; and acrylic polymers such as polymethyl(meth)acrylate, polyethyl(meth)acrylate, and polybutyl(meth)acrylate.

The resin bead as used herein is more positive than the charge of the binder resin in the triboelectric series and serves as a carrier that negatively charges a toner by friction between the resin bead and the binder resin. For example, when a polyester is used as the binder resin, a material that is more positive than the polyester, such as polystyrene, must be used as the resin bead. The weight average molecular weight of the polymer used as the resin bead is not particularly limited. However, the weight average molecular weight of 10,000-100,000 is preferable. If the weight average molecular weight is less than 10,000, phase change for long-term storage may occur. On the other hand, if the weight average molecular weight exceeds 100,000, the fixing property of the toner may be adversely affected.

The resin bead is preferably used in an amount of 0.1-2 wt %, more preferably 0.3-0.6 wt % based on the total weight of the toner. If the content of the resin bead is less than 0.1 wt %, an addition effect may be insufficient. On the other hand, if the amount of the resin bead exceeds 2 wt %, the feeding property of the developer may be lowered.

According to another embodiment of the present invention, the polymer used as the resin bead preferably has a glass transition temperature of 50-70° C. If the glass transition temperature is less than 50° C., the developer may be consolidated during storage at high temperature (referred to as a caking or blocking phenomenon). On the other hand, if it exceeds 70° C., the fixing property of the toner may be lowered.

In a non-contact developing method using a non-magnetic one-component developer, as the amount of printing increases, the developer is increasingly stressed. Therefore, the surface additive with a smaller average particle size, such as the silica and the titanium oxide, may be buried in the binder resin of the developer and the surface additive with a larger average particle size may be detached from mother particles of the developer. In this regard, the resin bead as used herein is the surface additive with a relatively large particle size, and thus, is detached from the mother particles of the developer due to increased stress with increasing the amount of printing. The detached resin bead is more positive than the silica and the titanium oxide in the triboelectric series, and thus, tends to attach to a relatively negatively charged feeding roller rather than the developing roller. Therefore, as the amount of printing increases, the amount of a residual resin bead in the developing system increases. Presumably, such a residual resin bead serves as a carrier having an opposite polarity to the developer, thereby providing uniform frictional chargeability. That is, it is judged that the resin bead serves as an opposite polarity carrier that prevents generation of an oppositely charged or uncharged developer, thereby reducing the fog density in a non-image area.

Preferably, the surface additive used in the non-magnetic one-component toner for a non-contact developing apparatus according to the present invention is a mixture of hydrophobic silica with the same polarity as the coloration particles, hydrophobic silica with opposite polarity to the coloration particles, and a resin bead with opposite polarity to the coloration particles. The hydrophobic silica surface additive with the same polarity as the coloration particles may be used in an amount of 0.01-2 wt %, based on the total weight of the toner particles. If the content of the hydrophobic silica with the same polarity as the coloration particles is less than 0.01 wt %, the flowability and chargeability of the toner particles may be lowered. On the other hand, if it exceeds 2 wt %, poor fixing property or image contamination may result.

The hydrophobic silica with opposite polarity to the coloration particles may have an average particle size of 30-50 nm and be used in an amount of 0.01-2 wt %, based on the total weight of the toner particles. If the average particle size of the hydrophobic silica with opposite polarity to the coloration particles is less than 30 nm, the effect of decreasing the fog in a non-image area may be insufficient and the fixing property may be lowered. On the other hand, if the average particle size exceeds 50 nm, the feeding property of the developer from a feeding roller to a developing roller may be lowered.

The toner according to the present invention can be made by melt mixing or polymerization. The surface additive can be attached to the toner particles by stirring the toner particles and the surface additive of a predetermined ratio in a stirrer such as a Henschel mixer. Alternatively, the surface additive can be attached to the toner particles so that at least a portion of the surface additive is buried in the surfaces of the toner particles by stirring the toner particles and the surface additive in a surface modifying apparatus such as “Nara hybridizer”.

Hereinafter, the present invention will be described more specifically by Examples. However, the following Examples are provided only for illustrations and thus the present invention is not limited to or by these examples.

### EXAMPLE 1

100 parts by weight of polystyrene with a weight average molecular weight of 30,000, 5 parts by weight of a carbon black (Degussa, Germany), and 2 parts by weight of a negative charge control agent (BONTRON S-54, Orient Chemical Industries, Ltd.) were premixed in a Henschel type mixer. The resultant mixture was fed into a twin-screw extruder and then extruded at 130° C., followed by cryogenic solidification. The resultant product was pulverized by a jet mill and then classified with an air or a wind classifier to give toner particles with an average particle size of about 8 μm. Then, 0.4 wt % of silica particles with an average volumetric particle size of 10 nm, 1.0 wt % of silica particles with an average volumetric particle size of 40 nm, and 0.5 wt % of titanium oxide with an average volumetric particle size of 10 nm, as additives for imparting flowability to the toner particles, were added and 0.1 parts by weight of polystyrene (based on 100 parts by weight of the toner particles) with a weight average molecular weight of 10,000 and an average volumetric particle size of 5 μm was then dispersed in the resultant mixture by a blender to obtain a non-magnetic one-component toner.

### EXAMPLE 2

A non-magnetic one-component toner was prepared in the same manner as in Example 1 except that 0.1 parts by weight of polystyrene with a weight average molecular weight of 10,000 and an average volumetric particle size of 10 μm was used.

### EXAMPLE 3

A non-magnetic one-component toner was prepared in the same manner as in Example 1 except that 0.1 parts by weight of polystyrene with a weight average molecular weight of 20,000 and an average volumetric particle size of 15 μm was used.

### EXAMPLE 4

A non-magnetic one-component toner was prepared in the same manner as in Example 1 except that 0.1 parts by weight of polyvinylidene fluoride with a weight average molecular weight of 15,000 and an average volumetric particle size of 10 μm was used.

### EXAMPLE 5

A non-magnetic one-component toner was prepared in the same manner as in Example 1 except that 0.1 parts by weight of polymethylmethacrylate with a weight average molecular weight of 30,000 and an average volumetric particle size of 10 μm was used.

### EXAMPLE 6

A non-magnetic one-component toner was prepared in the same manner as in Example 1 except that 0.5 parts by weight of polystyrene with a weight average molecular weight of 10,000 and an average volumetric particle size of 10 μm was used.

### EXAMPLE 7

A non-magnetic one-component toner was prepared in the same manner as in Example 1 except that 1 part by weight of polystyrene with a weight average molecular weight of 10,000 and an average volumetric particle size of 10 μm was used.

### EXAMPLE 8

100 parts by weight of polyester with a weight average molecular weight of 30,000, 5 parts by weight of a carbon black (Degussa, Germany), 2 parts by weight of a negative charge control agent (T-77, Fe complex, Hodogaya), and 2 parts by weight of a low molecular weight polypropylene wax were premixed in a Henschel type mixer. The resultant mixture was fed into a twin-screw extruder and then extruded at 130° C. followed by cryogenic solidification. The resultant product was pulverized by a jet mill and then classified with a wind classifier to give toner particles with an average particle size of about 8 μm. Then, a mixture of 1.0 wt % of silica particles with the same polarity as the toner particles (primary particle size: 7-16 nm, Nippon Aerosil), 0.3 wt % of silica particles with opposite polarity to the toner particles (primary particle size: 30-50 nm, Waker), and 0.3 wt % of a polystyrene based resin bead with opposite polarity to the toner particles (primary particle size: 0.1-15 μm, weight average molecular weight: 10,000), as a surface additive, was mixed with 100 parts by weight of the toner particles by a blender to obtain a non-magnetic one-component toner.

### COMPARATIVE EXAMPLE 1

A non-magnetic one-component toner was prepared in the same manner as in Example 1 except that a resin bead was not used.

### COMPARATIVE EXAMPLE 2

A non-magnetic one-component toner was prepared in the same manner as in Example 1 except that 0.1 parts by weight of polystyrene with a weight average molecular weight of 30,000 and an average volumetric particle size of 20 μm was used.

### COMPARATIVE EXAMPLE 3

A non-magnetic one-component toner was prepared in the same manner as in Example 8 except that a mixture of 1.0 wt % of silica particles with the same polarity as the toner particles (primary particle size: 7-16 nm, Nippon Aerosil) and 0.3 wt % of silica particles with opposite polarity to the toner particles (primary particle size: 30-50 nm, Nippon Aerosil) was used as a surface additive.

### EXPERIMENTAL EXAMPLE 1

### Fog Density Test

Each of the non-magnetic one-component toners of Examples 2, 8, and Comparative Examples 1-3 was set in a Samsung laser printer (speed: 124 mm/sec, A4 21 PPM) and a fog density was measured. The fog density was measured using a densitometer (RD918, Macbeth) and a tape 810D (3M) was used for fog density measurement. The fog density in a non-image area was measured by taping the surface of a latent image drum before transfer after suspending a printer during printing white papers and the results are summarized in Table 1 below.

TABLE 1

| | N.P* | | | | |
|---|---|---|---|---|---|
| Section | Initial | 2,000 | 4,000 | 6,000 | 8,000 |
| Example 2 | ◯ | ◯ | ◯ | ◯ | ⊚ |
| Example 8 | ⊚ | ⊚ | ⊚ | ⊚ | ⊚ |
| Comparative Example 1 | ◯ | Δ | X | X | X |
| Comparative Example 2 | ◯ | ◯ | Δ | Δ | X |
| Comparative Example 3 | X | X | X | X | X |

*N.P.: Number of papers
Fog density: 0.11 or less (excellent, ⊚), 0.11-0.13 (good, ◯), 0.14-0.15 (normal, Δ), 0.16 or more (poor, X)

As shown in Table 1, the toner of Comparative Example 1, resulted in fog density reaching such a level that the toner could no longer be used after printing 4,000 papers. As the number of printed papers increased, the fog density increased. The toner of Comparative Example 3 exhibited a severe fog density so that the toner could not be used even at an initial stage of printing. On the other hand, in connection with the toner of Example 2, the fog density was low at an initial stage of printing. As the amount of printing increased, the fog density decreased. The toner of Example 8 exhibited a very low fog density of 0.11 or less. From the above results, it can be seen that a toner of the present invention provides good image quality in which a fog in a non-image area is not generated as the amount of printing increases.

### EXPERIMENTAL EXAMPLE 2

### Image Contamination Test

Each of the non-magnetic one-component toners of Examples 1-8, and Comparative Examples 1-3 was set in Samsung laser printer (speed: 124 mm/sec, A4 21 PPM), like in Experimental Example 1, and 5% character patterns were continuously printed on 8,000 papers by using the Samsung laser printer at room temperature and humidity. The contamination in a non-image area by the toner was observed per 2,000 papers and the results are presented in Table 2 below.

As presented in Table 2 below, the toners of Examples 1-8 according to the present invention exhibited a good cleaning property and generated no image contamination even after 8,000 papers were printed. In connection with the toner of Comparative Example 1, an image contamination was observed after printing 6,000 papers. The toner of Comparative Example 2 exhibited a low image contamination level even when 8,000 papers were printed, but produced coarse halftone.

TABLE 2

| | N.P* | | | | |
|---|---|---|---|---|---|
| Section | Initial | 2,000 | 4,000 | 6,000 | 8,000 |
| Example 1 | ◯ | ◯ | ◯ | ◯ | ◯ |
| Example 2 | ◯ | ◯ | ◯ | ◯ | ◯ |
| Example 3 | ◯ | ◯ | ◯ | ◯ | ◯ |
| Example 4 | ◯ | ◯ | ◯ | ◯ | ◯ |
| Example 5 | ◯ | ◯ | ◯ | ◯ | ◯ |
| Example 6 | ◯ | ◯ | ◯ | ◯ | ◯ |
| Example 7 | ◯ | ◯ | ◯ | ◯ | ◯ |
| Example 8 | ◯ | ◯ | ◯ | ◯ | ◯ |
| Comparative Example 1 | ◯ | ◯ | Δ | X | X |
| Comparative Example 2 | ◯ | ◯ | ◯ | ◯ | Δ |
| Comparative Example 3 | ◯ | ◯ | ◯ | ◯ | ◯ |

*N.P.: Number of papers
◯: good,
Δ: usable,
X: poor (image contamination)

As apparent from the above description, a non-magnetic one-component toner for a non-contact developing apparatus according to the present invention can provide uniform image density for a longer duration and prevent the formation of a poor image such as a fog, without performing a separate process such as improving the pressure of a cleaning blade or the surface smoothness of a latent image drum.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A non-magnetic one-component toner, which comprises:
coloration particles comprising a binder resin, a pigment, and a charge control agent; and
a surface additive comprising 0.1-4 wt % of one or more components selected from the group consisting of silica, titanium oxide, silicon carbide, and alumina, and a resin bead having an average particle size of 0.01-15 μm and where said wt % is based on the total weight of said toner.

2. The non-magnetic one-component toner of claim 1, wherein said resin bead is selected from the group consisting of styrene polymers, fluorine polymers, and acrylic polymers.

3. The non-magnetic one-component toner of claim 1, wherein said resin bead is included in an amount of 0.01-2 wt % based on the total weight of said toner.

4. The non-magnetic one-component toner of claim 1, wherein said resin bead has a positive charge that is greater than a charge of said binder resin in the triboelectric series.

5. The non-magnetic one-component toner of claim 1, wherein said resin bead is a polymer having a glass transition temperature of 50-70° C.

6. The non-magnetic one-component toner of claim 1, wherein said binder resin is selected from the group consisting of styrenes, acrylics, ethers, esters, epoxies, and blends or copolymers thereof.

7. The non-magnetic one-component toner of claim 1, wherein said surface additive is a mixture of hydrophobic silica having a polarity that is the same as a polarity of said coloration particles, hydrophobic silica having an opposite polarity from said colorant particles, and a resin bead having an opposite polarity of said coloration particles.

8. The non-magnetic one-component toner of claim 1, wherein said surface additive is hydrophobic silica having a polarity that is the same as a polarity of said coloration particles and wherein said surface additive is included in an amount of 0.01-2 wt %, based on the total weight of said toner.

9. The non-magnetic one-component toner of claim 1, wherein said surface additive is hydrophobic silica having a polarity that is opposite a polarity of said coloration particles and has an average particle size of 30-50 nm and is included in an amount of 0.01-2 wt %, based on the total weight of said toner.

10. The non-magnetic one-component toner of claim 1, wherein said resin is a polymer having a weight average molecular weight of 10,000-100,000.

11. The non-magnetic one-component toner of claim 1, wherein said resin bead has an average particle size of 5-15 μm.
